(19) United States
(12) Patent Application Publication
(10) Pub. No.: US 2026/0267684 A1
(43) Pub. Date: Sep. 10, 2026

(54) POLICY SELECTION APPARATUS, POLICY SELECTION METHOD, AND NON-TRANSITORY COMPUTER-READABLE RECORDING MEDIUM

(71) Applicant: NEC Corporation, Tokyo (JP)

(72) Inventors: Natsuhiko SATO, Tokyo (JP); Hiroshi YOSHIDA, Tokyo (JP)

(73) Assignee: NEC Corporation, Tokyo (JP)

(21) Appl. No.: 19/390,936

(22) Filed: Nov. 17, 2025

(30) Foreign Application Priority Data
Mar. 4, 2025 (JP) 2025-033968

(51) Int. Cl. G06F 9/48

(52) U.S. Cl. CPC G06F 9/485

(57) ABSTRACT

A policy selection apparatus includes an evaluation distribution calculation unit that calculates an evaluation distribution for each of a plurality of policies, a synthesized evaluation distribution calculation unit that calculates a synthesized evaluation distribution based on the evaluation distribution, a specification unit that specifies a combination of policies having the highest possibility of achieving an objective in the case where a remaining number of tasks are performed based on the synthesized evaluation distribution, and a selection unit that selects a next policy from the policies included in the combination specified by the specification means.

This application is based upon and claims the benefit of priority from Japanese Patent Application No. 2025-033968, filed on Mar. 4, 2025, the disclosure of which is incorporated herein in its entirety by reference.

### TECHNICAL FIELD

The present disclosure relates to a policy selection apparatus, a policy selection method, and a policy selection program.

### BACKGROUND ART

There is known a technique of generating a plurality of policies and switching and using the policies at the time of application. For example, T. Saiki and S. Arai, “Switching Policies based on Multi-Objective Reinforcement Learning for Adaptive Traffic Signal Control,” 2022 61st Annual Conference of the Society of Instrument and Control Engineers (SICE), Kumamoto, Japan, 2022, pp. 488-493 describes a technique of generating a plurality of control laws for signal control using multi-objective reinforcement learning and switching the control laws according to a traffic volume (flow rate).

### SUMMARY

A policy selection apparatus according to an exemplary aspect of the present disclosure is a policy selection apparatus that selects a policy to be used by an agent in a next task from a plurality of policies each time for sequential execution of a plurality of tasks executed by the agent that operates autonomously, wherein an objective for a value cumulatively obtained from an evaluation value for each task is set in the plurality of tasks, the policy selection apparatus including an evaluation distribution calculation unit that calculates an evaluation distribution indicating a distribution of evaluation values in the case where one task is executed for each of the plurality of policies, a synthesized evaluation distribution calculation unit that calculates, based on the evaluation distribution, a synthesized evaluation distribution obtained by estimating a distribution of evaluation values in the case where any number of tasks are executed with any combination of policies, a specification unit that specifies, based on the synthesized evaluation distribution, a combination of policies that are most likely to achieve the objective in the case where a remaining number of tasks are performed, and a selection unit that selects a policy to be used by the agent in the next task from the policies included in the combination specified by the specification means.

A policy selection method according to an exemplary aspect of the present disclosure is a policy selection method for selecting a policy to be used by an agent in a next task from a plurality of policies each time for sequential execution of a plurality of tasks executed by the agent that operates autonomously, wherein an objective for a value cumulatively obtained from an evaluation value for each task is set in the plurality of tasks, the policy selection method including calculating an evaluation distribution indicating a distribution of evaluation values in the case where one task is executed for each of the plurality of policies, calculating, based on the evaluation distribution, a synthesized evaluation distribution obtained by estimating a distribution of evaluation values in the case where any number of tasks are executed with any combination of policies, specifying, based on the synthesized evaluation distribution, a combination of policies that are most likely to achieve the objective in the case where a remaining number of tasks are performed, and selecting a policy to be used by the agent in the next task from the policies included in the combination specified.

A policy selection program according to an exemplary aspect of the present disclosure is a policy selection program for causing a computer to function as a policy selection apparatus that selects a policy to be used by an agent in a next task from a plurality of policies each time for sequential execution of a plurality of tasks executed by the agent that operates autonomously, wherein an objective for a value cumulatively obtained from an evaluation value for each task is set in the plurality of tasks, the policy selection program causing the computer to function as the policy selection program causes the computer to execute: an evaluation distribution calculation unit that calculates an evaluation distribution indicating a distribution of evaluation values in the case where one task is executed for each of the plurality of policies, a synthesized evaluation distribution calculation unit that calculates, based on the evaluation distribution, a synthesized evaluation distribution obtained by estimating a distribution of evaluation values in the case where any number of tasks are executed with any combination of policies, a specification unit that specifies, based on the synthesized evaluation distribution, a combination of policies that are most likely to achieve the objective in the case where a remaining number of tasks are performed, and a selection unit that selects a policy to be used by the agent in the next task from the policies included in the combination specified by the specification means.

### BRIEF DESCRIPTION OF THE DRAWINGS

FIG. 1 is a first block diagram illustrating a configuration of a policy selection apparatus according to the present disclosure;

FIG. 2 is a first flowchart illustrating a flow of a policy selection method according to the present disclosure;

FIG. 3 is a second block diagram illustrating a configuration of a policy selection apparatus according to the present disclosure;

FIG. 4 is a second flowchart illustrating a flow of a policy selection method according to the present disclosure;

FIG. 5 is a schematic diagram illustrating an example of an environment provided by an environment execution unit according to the present disclosure;

FIG. 6 is a flowchart illustrating a flow of reinforcement learning for generating a learning model that enables a policy according to the present disclosure;

FIG. 7 is a diagram illustrating a flow of data in a policy learning apparatus for generating a policy according to the present disclosure;

FIG. 8 is a flowchart illustrating a flow of processing executed by a policy learning apparatus for generating a policy according to the present disclosure;

FIG. 9 is a diagram for explaining an example of a task according to the present disclosure;

FIG. 10A is a first diagram illustrating a first execution result of a task according to the present disclosure;

FIG. 10B is a second diagram illustrating a first execution result of a task according to the present disclosure;

FIG. 10C is a third diagram illustrating a first execution result of a task according to the present disclosure;

FIG. 10D is a fourth diagram illustrating a first execution result of a task according to the present disclosure;

FIG. 11A is a first diagram illustrating a second execution result of a task according to the present disclosure;

FIG. 11B is a second diagram illustrating a second execution result of a task according to the present disclosure;

FIG. 11C is a third diagram illustrating a second execution result of a task according to the present disclosure;

FIG. 11D is a fourth diagram illustrating a second execution result of a task according to the present disclosure;

FIG. 12 is a diagram for explaining selection of a policy according to the present disclosure;

FIG. 13 is a diagram illustrating a third execution result of a task according to the present disclosure; and

FIG. 14 is a block diagram illustrating a configuration of a computer that functions as each apparatus according to the present disclosure.

### EXAMPLE EMBODIMENT

Hereinafter, example embodiments of the present disclosure will be exemplified. However, the present disclosure is not limited to the following exemplary example embodiments, and various modifications can be made within a scope described in the claims. For example, example embodiments obtained by appropriately combining technologies (some or all of things or methods) adopted in the following exemplary example embodiments can also be included in the scope of the present disclosure. Example embodiments obtained by appropriately omitting some of the technologies adopted in the following exemplary example embodiments can also be included in the scope of the present disclosure. Effects mentioned in the following exemplary example embodiments are examples of effects expected in the exemplary example embodiments, and do not define extension of the present disclosure. In other words, example embodiments that do not provide the effects mentioned in the following exemplary example embodiments can also be included in the scope of the present disclosure.

### First Exemplary Example Embodiment

A first exemplary example embodiment that is an example of the example embodiments of the present disclosure will be described in detail with reference to the drawings. The present exemplary example embodiment is a basic form of each exemplary example embodiment to be described below. An application range of each technique adopted in the present exemplary example embodiment is not limited to the present exemplary example embodiment. That is, each technique adopted in the present exemplary example embodiment may also be adopted in another exemplary example embodiment included in the present disclosure as long as no particular technical problem is raised. Each technology illustrated in the drawings referred to for describing the present exemplary example embodiment can also be adopted in another exemplary example embodiment included in the present disclosure within a range in which no particular technical problem occurs.

### (Configuration of Policy Selection Apparatus)

A policy selection apparatus 1 is an apparatus that selects a policy to be used by an agent. An agent refers to an apparatus that operates autonomously. In the present example embodiment, the agent sequentially executes a plurality of tasks. The type of task is not particularly limited, and includes, for example, tasks related to information processing such as gambling, trade, and game in addition to tasks related to operation, measurement, and the like of a real object such as movement (for example, transportation), production (for example, processing), measurement, and monitoring (for example, security).

The policy selection apparatus 1 selects a policy to be used by the agent in the next task from a plurality of policies each time. The policy is a policy for determining the next action to be executed by the agent. For example, the entity of the policy may be artificial intelligence (AI) that determines the next action to be executed by the agent. That is, selecting a policy may be selecting AI.

In the present example embodiment, an objective for a value cumulatively obtained from an evaluation value for each task is set in a plurality of tasks executed by the agent. That is, consider a situation where one major purpose is constituted by a plurality of partial tasks, and a value cumulatively obtained from an evaluation value for each task is important. The evaluation value is a value obtained by evaluating a result of execution of the task by the agent. The evaluation value may be, for example, a value calculated by measuring or analyzing the target object of the task (which may be the agent itself). The value (overall index) cumulatively obtained from the evaluation value for each task only needs to be an index that can be sequentially calculated from the evaluation value for each task, and for example, only needs to be an index in which a recurrence formula can be set for the overall index R. Examples of the overall index R include a sum of evaluation values calculated by a recurrence formula such as R{n+1}=R{n}+r{n}(where r{n} is the evaluation value for the nth task), a discount cumulative sum of evaluation values calculated by a recurrence formula such as R{n+1}=T (constant)×R{n}+r{n}, and the like. The policy selection apparatus 1 selects each policy so as to improve the possibility of achieving the overall objective.

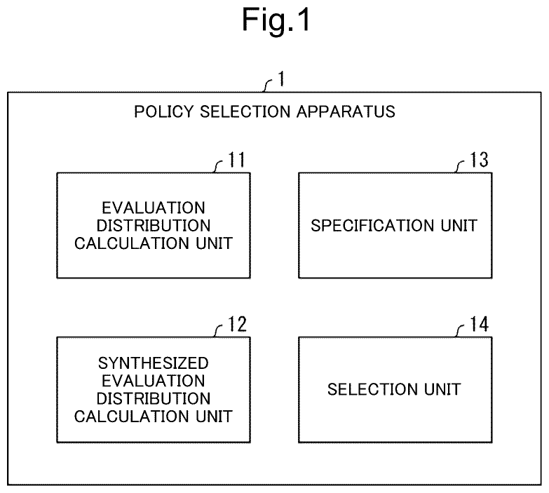

The configuration of the policy selection apparatus 1 will be described with reference to FIG. 1. FIG. 1 is a first block diagram illustrating a configuration of the policy selection apparatus 1. As illustrated in FIG. 1, the policy selection apparatus 1 includes an evaluation distribution calculation unit 11, a synthesized evaluation distribution calculation unit 12, a specification unit 13, and a selection unit 14. The policy selection apparatus 1 may be configured to be able to communicate with an agent or may be included in the agent.

The evaluation distribution calculation unit 11 calculates an evaluation distribution for each of the plurality of policies. The evaluation distribution indicates a distribution of evaluation values when one task is executed. In one aspect, the evaluation distribution calculation unit 11 may cause an agent to actually execute a task using one policy in an actual environment where the task is executed, and calculate a distribution of evaluation values obtained as a result of the task as the evaluation distribution of the policy.

The evaluation distribution calculation unit 11 may calculate the evaluation distribution using a simulation model instead of the actual environment.

The synthesized evaluation distribution calculation unit 12 calculates a synthesized evaluation distribution based on the evaluation distribution calculated by the evaluation distribution calculation unit 11. The synthesized evaluation distribution is obtained by estimating a distribution of evaluation values in the case where any number of tasks are executed with any combination of policies.

For example, the synthesized evaluation distribution calculation unit 12 calculates distribution of evaluation values when X (X is an integer equal to or more than 1 and equal to or less than the total number of tasks) tasks are executed in each combination selected from a plurality of policies (the same policy can be selected a plurality of times). In a case where X is 1, the evaluation distribution itself may be used.

The specification unit 13 specifies a combination of policies based on the synthesized evaluation distribution calculated by the synthesized evaluation distribution calculation unit 12. The combination of policies specified by the specification unit 13 is a combination of policies having the highest possibility of achieving the objective when the remaining number of tasks is executed. For example, in a case where the value cumulatively obtained from the evaluation value for each task is the sum of the evaluation values, achieving the objective means that the sum of the evaluation values when all the tasks are executed is equal to or more than the target value. Therefore, when a value obtained by subtracting the sum of the evaluation values of the tasks already executed from the target value is called the remaining target value, the combination of policies specified by the specification unit 13 can also be regarded as a combination of policies having the highest possibility that the sum of the evaluation values when the remaining number of tasks are executed is equal to or more than the remaining target value. In a case where the value cumulatively obtained from the evaluation value for each task is obtained by the recurrence formula, achieving the objective means that the value of the recurrence formula when all the tasks are executed is equal to or more than the target value. Therefore, the combination of policies specified by the specification unit 13 can also be referred to as a combination of policies having the highest possibility that the value of the recurrence formula calculated from the evaluation value when the remaining number of tasks are executed using the value of the recurrence formula calculated from the evaluation value of the task already executed is equal to or more than the target value.

For example, in a case where the value cumulatively obtained from the evaluation value for each task is the sum of the evaluation values, the specification unit 13 specifies, before the first task, a combination of policies having the highest possibility that the sum of the evaluation values when the task is executed the total number of times is equal to or more than the target value. Before the second task, the specification unit 13 specifies a combination of policies having the highest possibility that the sum of evaluation values when the task is executed the number of times obtained by subtracting 1 from the total number of times becomes equal to or more than the remaining target value (value obtained by subtracting the first evaluation value from the target value). Before the third task, the specification unit 13 specifies a combination of policies having the highest possibility that the sum of evaluation values when the task is executed the number of times obtained by subtracting 2 from the total number of times becomes equal to or more than the remaining target value (value obtained by subtracting the first and second evaluation values from the target value). The same applies hereinafter.

In a case where a value cumulatively obtained from the evaluation value for each task is obtained by the recurrence formula, the specification unit 13 specifies, before the first task, a combination of policies having the highest possibility that the value of the recurrence formula calculated from each evaluation value when the task is executed the total number of times is equal to or more than the target value. Before the second task, the specification unit 13 uses the value of the recurrence formula calculated from the first evaluation value to specify a combination of policies having the highest possibility that the value of the recurrence formula calculated from the evaluation value when the task is executed the number of times obtained by subtracting 1 from the total number of times is equal to or more than the target value. Before the third task, the specification unit 13 uses the value of the recurrence formula calculated from the evaluation values of the first to second tasks to specify a combination of policies having the highest possibility that the value of the recurrence formula calculated from the evaluation values when the task is executed the number of times obtained by subtracting 2 from the total number of times is equal to or more than the target value. The same applies hereinafter.

The selection unit 14 selects a policy to be used by the agent in the next task from the policies included in the combination specified by the specification unit 13.

### (Effects of Policy Selection Apparatus)

As described above, the policy selection apparatus 1 employs a configuration in which a combination of policies having the highest possibility of achieving the objective when the remaining number of tasks are executed is specified based on a synthesized evaluation distribution obtained by estimating a distribution of evaluation values when any number of tasks are executed with any combination of policies, and a next policy is selected from policies included in the specified combination. As a result, the policy selection apparatus 1 can improve the success probability by selecting each policy according to the situation at that time. For this reason, according to the policy selection apparatus 1, it is possible to provide a technique of selecting a policy for each task so that the possibility of achieving the objective as a whole is increased in sequential execution of a plurality of tasks.

### (Flow of Policy Selection Method)

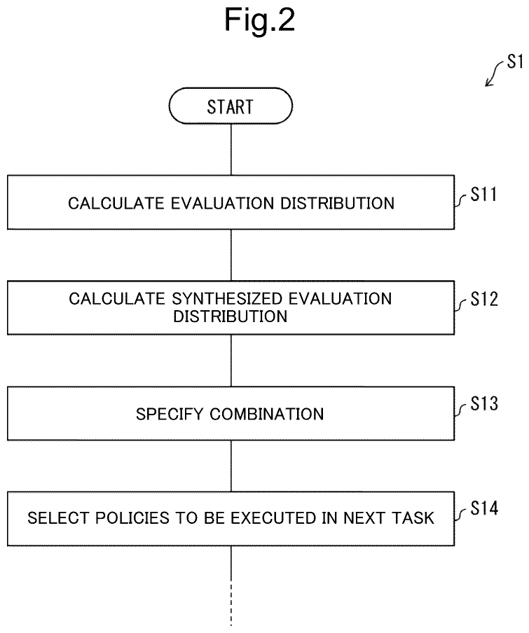

The flow of the policy selection method S1 will be described with reference to FIG. 2. FIG. 2 is a first flowchart illustrating a flow of the policy selection method S1. As illustrated in FIG. 2, the policy selection method S1 includes evaluation distribution calculation processing S11, synthesized evaluation distribution calculation processing S12, specification processing S13, and selection processing S14. The policy selection method S1 is executed by, for example, the policy selection apparatus 1.

The policy selection method S1 is a method of selecting a policy to be used by an agent in the next task from a plurality of policies each time for sequential execution of a plurality of tasks executed by the agent that operates autonomously. Objectives for values cumulatively obtained from evaluation values for each task are set for the plurality of tasks.

In the evaluation distribution calculation processing S11, for example, the policy selection apparatus 1 calculates an evaluation distribution indicating a distribution of evaluation values when one task is executed for each of a plurality of policies.

In the synthesized evaluation distribution calculation processing S12, for example, the policy selection apparatus 1 calculates, based on the calculated evaluation distribution, a synthesized evaluation distribution obtained by estimating a distribution of evaluation values when any number of tasks are executed with any combination of policies.

In the specification processing S13, for example, the policy selection apparatus 1 specifies, based on the calculated synthesized evaluation distribution, a combination of policies having the highest possibility of achieving the objective when the remaining number of tasks are executed.

In the selection processing S14, for example, the policy selection apparatus 1 selects a policy to be used by the agent in the next task from the policies included in the specified combination.

### (Effects of Policy Selection Method)

As described above, in the policy selection method S1, a configuration is adopted in which a combination of policies having the highest possibility of achieving the objective when the remaining number of tasks are executed is specified based on a synthesized evaluation distribution obtained by estimating a distribution of evaluation values when any number of tasks are executed in any policy combination, and a next policy is selected from policies included in the specified combination. For this reason, according to the policy selection method S1, it is possible to provide a technique of selecting a policy for each task so that the possibility of achieving the objective as a whole is increased in the sequential execution of the plurality of tasks.

### Second Exemplary Example Embodiment

A second exemplary example embodiment that is an example of the example embodiments of the present disclosure will be described in detail with reference to the drawings. Components that have the same functions as the components described in the above-described exemplary example embodiment are denoted by the same reference signs, and will not be described as appropriate. An application range of each technique adopted in the present exemplary example embodiment is not limited to the present exemplary example embodiment. That is, each technique adopted in the present exemplary example embodiment may also be adopted in another exemplary example embodiment included in the present disclosure as long as no particular technical problem is raised. Each technique illustrated in each of the drawings referred to for describing the present exemplary example embodiment can be employed in the other exemplary example embodiments included in the present disclosure within the scope in which no particular technical problem occurs.

### (Configuration of Policy Selection Apparatus)

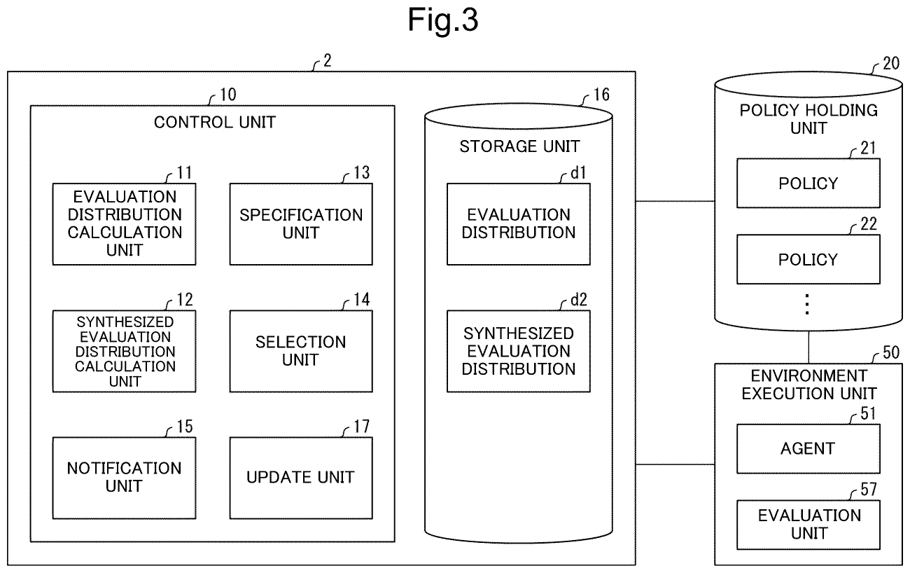

The configuration of a policy selection apparatus 2 will be described with reference to FIG. 3. FIG. 3 is a second block diagram illustrating a configuration of the policy selection apparatus 2. The policy selection apparatus 2 includes a notification unit 15, a storage unit 16, and an update unit 17 in addition to the evaluation distribution calculation unit 11, the synthesized evaluation distribution calculation unit 12, the specification unit 13, and the selection unit 14 included in the policy selection apparatus 1. The evaluation distribution calculation unit 11, the synthesized evaluation distribution calculation unit 12, the specification unit 13, the selection unit 14, the notification unit 15, and the update unit 17 are provided in the control unit 10 of the policy selection apparatus 2.

The notification unit 15 notifies the user of the policy selection apparatus 2. The notification method is not particularly limited, and examples thereof include causing a display apparatus to display a message, causing a speaker to output a warning sound, and transmitting a message to a predetermined destination.

The storage unit 16 is a storage for storing data. The storage unit 16 stores the evaluation distribution d1 and the synthesized evaluation distribution d2.

The update unit 17 updates the evaluation distribution d1 and the synthesized evaluation distribution d2 stored in the storage unit 16.

The policy selection apparatus 2 is configured to be able to communicate with a policy holding unit 20 and an environment execution unit 50. In one aspect, the policy selection apparatus 2 may include at least one of the policy holding unit 20 or the environment execution unit 50.

The policy holding unit 20 holds a plurality of policies to be selected, such as a policy 21 and a policy 22, for example. In one aspect, in a case where any policy is enabled by a learned model, the policy holding unit 20 may hold a learned model related to the policy. In a case where any policy is enabled by rule-based AI, a rule group related to the policy may be held.

The environment execution unit 50 provides an environment in which an agent 51 executes a task and/or an environment for executing a simulation model of the environment. The environment execution unit 50 includes the agent 51 that executes a task and an evaluation unit 57 that calculates an evaluation value of the task executed by the agent 51.

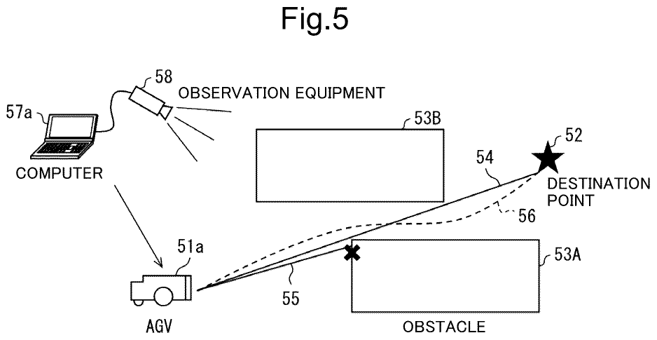

FIG. 5 illustrates an example of an environment provided by the environment execution unit 50. However, the environment execution unit 50 is not limited to the configuration illustrated in FIG. 5 as long as it is configured to execute an environment in which the agent 51 can execute a task and evaluate a result thereof or a simulation model thereof.

The environment illustrated in FIG. 5 is an environment in which an AGV51a as the agent 51 executes a task of moving to a destination point 52. The environment includes obstacles 53 (53A and 53B), observation equipment 58, and a computer 57a. The computer 57a functions as the evaluation unit 57.

A predetermined policy is set for the AGV51a. The observation result of the observation equipment 58 is transmitted to the AGV51a via the computer 57a. The AGV51a calculates a route (for example, routes 54 to 56, or the like) to the destination point 52 based on the set policy and the observation result. The computer 57a calculates an evaluation value of the task executed by the AGV51a based on the observation result.

### (Plurality of Policies to be Selected)

Next, a plurality of policies to be selected by the policy selection apparatus 2 will be described. Each policy may be enabled by a learning model or may be enabled by using a non-learning model (for example, rule-based AI).

In a case where each policy is enabled by a learning model, in one aspect, the agent 51 may determine an autonomous operation using a learning model related to the policy.

The learning model related to each policy is not particularly limited, but in one aspect, the learning model may be a learning model subjected to reinforcement learning with a reward based on an expected value and a variance of an evaluation value of a task. At this time, the plurality of policies to be selected by the policy selection apparatus 2 may be policies in which the agent 51 operates using learning models in which reinforcement learning in which weightings of variance with respect to an expected value in reward are different from each other is performed.

As described above, in one aspect, the plurality of policies to be selection candidates can be configured as a plurality of policies in which variations in results and expected values are in a trade-off relationship, and a balance between variations in results and expected values is different from each other. In this case, in a case where a high evaluation value is obtained in the early stage, the policy selection apparatus 1 can safely achieve the objective by selecting a risk avoidance policy thereafter, and in a case where the evaluation value obtained in the early stage is low, the policy selection apparatus 1 can aim to achieve the objective by selecting a risk preference policy. As a result, the policy selection apparatus 1 can select a policy according to the situation and increase the success probability.

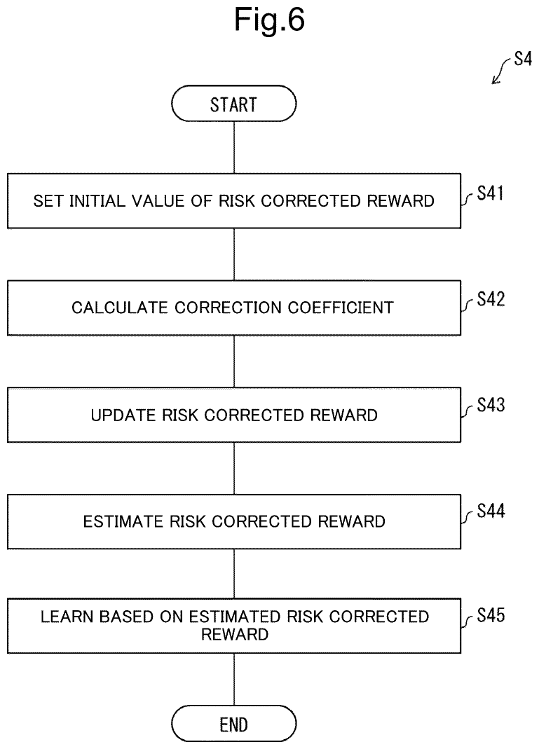

Hereinafter, an example of a learning method of such a learning model will be described. FIG. 6 is a flowchart illustrating a flow S4 of reinforcement learning for generating a learning model that enables a policy.

In step S41, an initial value of a risk corrected reward that is a reward considering a risk is set. The initial value of the risk corrected reward is not particularly limited, and examples thereof include a random value and a value obtained by performing learning without risk correction.

The risk corrected reward is a value calculated using the following Expression (1), where σ is a standard deviation of the reward, c is a predetermined parameter, and is an expected value of the reward obtained by the next action.

$$v = μ - c σ \qquad ( 1 )$$

In step S42, a correction coefficient is calculated based on a predetermined parameter regarding a risk for the reward, a risk corrected reward, and a difference between a reward obtained by a next action and the risk corrected reward.

Here, the predetermined parameter for the reward is a parameter of risk preference/avoidance of a preset real value.

When the reward obtained by the next action is r, the difference δ is calculated using the following Expression (2).

$$δ = r - v \qquad ( 2 )$$

Furthermore, the correction coefficient ξ is calculated using the following Expressions (3) to (5).

$$[ Math . 1 ]$$

$$f ( c ) = \frac{c}{c \cdot erf ( \frac{c}{\sqrt{2}} ) + \sqrt{\frac{2}{π}} exp ( \frac{- {c}^{2}}{2} )} \qquad ( 3 )$$

Here, erf is an error function. The following Expression (4) is calculated for the predetermined parameter c.

$$[ Math . 2 ]$$

$$a = ( \frac{1 + f ( c )}{1 - f ( c )} ) \qquad ( 4 )$$

At this time, the correction coefficient ξ is expressed by the following Expression (5).

$$[ Math . 3 ]$$

$$ξ = \frac{2 α}{1 + {α}^{- sgn ( δ )}} \qquad ( 5 )$$

Here, sgn is a sign function.

That is, the correction coefficient ξ is calculated using the following Expression (6) when δ>0 and using the following Expression (7) when δ<0.

$$[ Math . 4 ]$$

$${ξ}_{+} = \frac{2 α}{1 + {α}^{- 1}} \qquad ( 6 )$$

$$[ Math . 5 ]$$

$${ξ}_{-} = \frac{2 α}{1 + α} \qquad ( 7 )$$

In step S13, the risk corrected reward is updated based on the risk corrected reward, the correction coefficient, and the difference.

Here, the risk corrected reward ν is updated using the following Expression (8).

$$v ← v + ξδ \qquad ( 8 )$$

In step S14, the risk corrected reward is estimated by processing of calculating a correction coefficient using the updated risk corrected reward and processing of updating the risk corrected reward using the updated risk corrected reward and the correction coefficient.

In step S15, learning is performed based on the estimated risk corrected reward.

(Proof that Update has Unique and Stable Fixed Point)

In the following, it is proved that when the reward is a normal distribution, this update of the risk corrected reward has a unique and stable fixed point ν*, and the fixed point ν* matches μ+cσ.

The update having a unique and stable fixed point ν* means that the expected value J(ν) of the update satisfies the following Expressions (9) to (11).

$$J ( v ) < 0 if v > {v}^{*} \qquad ( 9 )$$

$$J ( v ) = 0 if v = {v}^{*} = μ + c σ \qquad ( 10 )$$

$$J ( v ) > 0 if v < {v}^{*} \qquad ( 11 )$$

That is, the expected value J(ν) of the update indicates that, in a case where the value of the estimated risk corrected reward ν is larger than ν*, ν is updated to a smaller value as the expected value. The expected value J(ν) of the update indicates that in a case where the value of the estimated risk corrected reward ν is smaller than ν*, ν is updated to a larger expected value. The expected value J(ν) of the update indicates that the expected value of the update amount of ν is 0 in a case where the value of the estimated risk corrected reward ν is equal to ν*.

Here, when Expression (8) described above is rewritten using the following Expression (12), Expression (13) is obtained.

$$[ Math . 6 ]$$

$$b = log ( \frac{1 + f ( c )}{1 - f ( c )} ) \qquad ( 12 )$$

$$[ Math . 7 ]$$

$$v ← v + α \frac{2 δ}{1 + exp ( - b \cdot sgn ( δ ) )} \qquad ( 13 )$$

In Expression (13), since the second term on the right side indicates the update amount, the expected value of the update amount is Expression (14).

$$[ Math . 8 ]$$

$$J ( v ) := 2 {\int }_{- ∞}^{∞} \frac{N ( x ; μ , {σ}^{2} ) ( x - v )}{1 + exp ( - b \cdot sgn ( x - v ) )} dx \qquad ( 14 )$$

Here, when variable transformation of ν=μ+tσ and ν→t is performed in Expression (14), the following Expression (15) is obtained.

$$[ Math . 9 ]$$

$$J ( v = μ + t σ ) = σ \text{} ( \text{} \frac{1}{1 + exp ( - b )} + \frac{1}{1 + exp ( b )} ) \text{} ( tanh \frac{b}{2} ( t \cdot erf ( \frac{t}{\sqrt{2}} ) + \sqrt{\frac{2}{π}} exp ( - \frac{{t}^{2}}{2} ) ) - t ) \qquad ( 15 )$$

Here, when Expression (15) and the following Expression (16) are used, J(ν*)=0 when ν=ν*=μ+cσ. This proved Expression (10).

$$[ Math . 10 ]$$

$$tanh \frac{b}{2} = f ( c ) \qquad ( 16 )$$

J is continuous and differentiable with respect to ν, and dJ/dν<0. That is, J is monotonically decreasing in a narrow sense, and Expressions (9) and (11) are proved by proven Expression (10).

As described above, since the expected value J(ν) of the update satisfies the Expressions (9) to (11), the update has a unique and stable fixed point ν*=μ+cσ.

By performing reinforcement learning as described above, even in two environments with different rewards, a risk corrected reward is used, and a degree of risk consideration does not change according to a predetermined parameter. Therefore, it is possible to provide reinforcement learning suitable for a case of using one estimation amount.

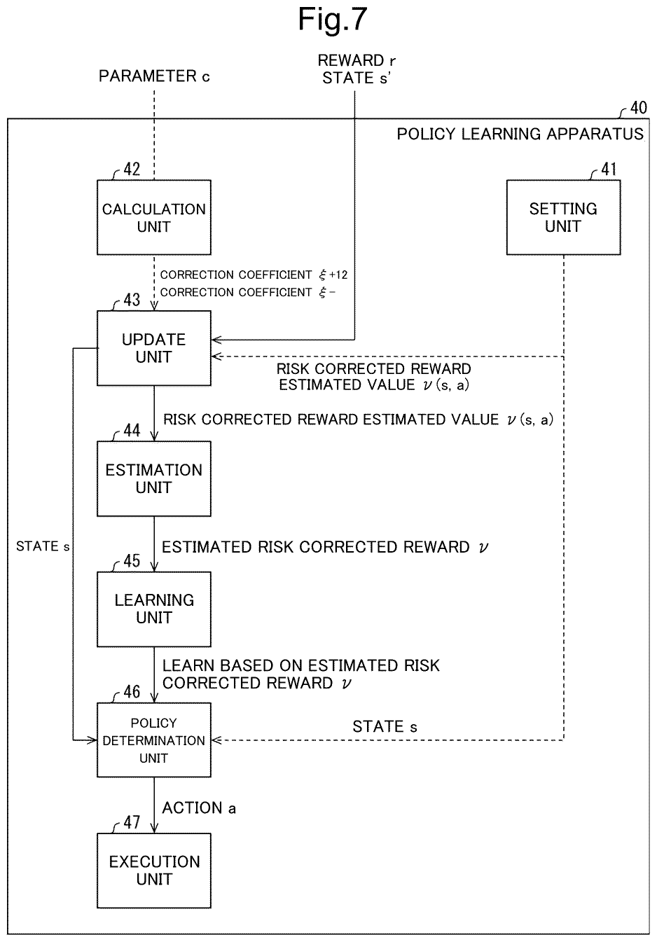

Next, an example of a policy learning apparatus 40 that performs reinforcement learning will be described in detail. FIG. 7 is a diagram illustrating a flow of data in the policy learning apparatus 40. As illustrated in FIG. 7, the policy learning apparatus 40 includes a setting unit 41, a calculation unit 42, an update unit 43, an estimation unit 44, a learning unit 45, a policy determination unit 46, and an execution unit 47.

The setting unit 41 sets an initial parameter for the estimation unit 44 to estimate a risk corrected reward ν that is a reward considering a risk. Examples of the setting unit 41 include an initial value of the risk corrected reward ν and a weight of a neural network for the estimation unit 44 to estimate the risk corrected reward ν.

The setting unit 41 generates a state action-value function of an array ν(S, A) of estimated values of the risk corrected reward for the action a in the state s.

The calculation unit 42 calculates the correction coefficient ξ based on the parameter c, the risk corrected reward ν, and the difference δ between the reward r obtained by the next action and the risk corrected reward. Examples of a method of calculating the correction coefficient ξ include methods using the above-described Expressions (3) to (5). The calculation unit 42 calculates the correction coefficient ξ₊ and the correction coefficient ξ₋. Examples of a method of calculating the correction coefficient ξ₊ and the correction coefficient ξ₋ include a method using the above-described Expressions (6) and (7).

The update unit 43 updates the risk corrected reward based on the risk corrected reward ν, the correction coefficient ξ, and the difference δ. Examples of a method of updating the risk corrected reward ν include a method using the above-described Expression (8). That is, the update unit 43 updates the risk corrected reward ν by adding the risk corrected reward ν to a value obtained by multiplying the correction coefficient ξ by the difference δ.

As an example, the update unit 43 calculates the difference δ using the following Expression (17).

$$δ = r + γ {v}^{′} ( {s}^{′} , a ) - v ( s , a ) \qquad ( 17 )$$

Here, γ represents a discount rate.

The estimation unit 44 estimates the risk corrected reward ν by processing in which the calculation unit 42 calculates the correction coefficient ξ using the risk corrected reward ν updated by the update unit 43 and processing in which the update unit 43 updates the risk corrected reward ν using the risk corrected reward ν updated by the update unit 43 and the correction coefficient ξ. As an example, the estimation unit 44 may be an estimation means having parameters such as a neural network.

The learning unit 45 performs learning based on the updated risk corrected reward. As an example, the learning unit 45 causes the policy determination unit 46 to learn based on the updated risk corrected reward ν.

The policy determination unit 46 is learned by the learning unit 45 so that the execution unit 47 outputs the action a to be executed by the agent with the state s as an input.

The execution unit 47 causes the agent to execute the action a output from the policy determination unit 46. The execution unit 47 may be the same as or different from the environment execution unit 50.

The execution unit 47 may cause the agent to execute the action a in simulation.

Next, a flow of data in the policy learning apparatus 40 will be described. First, as indicated by dotted lines in FIG. 7, data is processed. That is, the calculation unit 42 acquires the parameter c and calculates the correction coefficient ξ₊ and the correction coefficient ξ₋. The calculation unit 42 supplies the calculated correction coefficient ξ₊ and correction coefficient ξ₋ to the update unit 43.

The setting unit 41 generates a state action-value function of an array ν(S, A) of estimated values of the risk corrected reward ν. The setting unit 41 sets a risk corrected reward estimated value ν(s, a), which is a value of the risk corrected reward in the case of the initial state s and the action a, as an initial value of the risk corrected reward ν. The setting unit 41 supplies the set risk corrected reward estimated value ν(s, a) to the update unit 43. The setting unit 41 supplies the state s to the policy determination unit 46.

Subsequently, the data is processed as indicated by the solid lines in FIG. 7. That is, the policy determination unit 46 outputs the action a to the execution unit 47. The execution unit 47 causes the agent to execute the action a.

Then, when the agent executes the action a, the update unit 43 acquires the reward r. The update unit 43 acquires the next state s′. Then, the update unit 43 calculates the risk corrected reward estimated value ν(s′, a) of the next state s′ and the action a, and the difference δ.

The update unit 43 updates the risk corrected reward ν that is an estimation amount based on the risk corrected reward estimated value ν(s, a), the difference δ, the correction coefficient ξ₊, and the correction coefficient ξ₋. Specifically, as described above, the update unit 43 updates the risk corrected reward ν using either the correction coefficient ξ₊ or the correction coefficient ξ₋ according to the positive or negative of the difference δ. With this configuration, the update unit 43 can sequentially obtain a good estimation amount. In other words, the calculation unit 42 calculates either the correction coefficient ξ₊ or the correction coefficient ξ₋ according to the positive or negative of the difference δ, and supplies the same to the update unit 43.

Then, the update unit 43 supplies the updated risk corrected reward estimated value ν(s, a) to the estimation unit 44. The update unit 43 updates the state s and supplies the updated state s to the policy determination unit 46.

The estimation unit 44 acquires a plurality of the risk corrected reward estimated values ν(s, a) by processing in which the calculation unit 42 calculates the correction coefficient ξ and processing in which the update unit 43 updates the risk corrected reward estimated value ν(s, a). Then, the estimation unit 44 estimates the risk corrected reward ν. The estimation unit 44 supplies the estimated risk corrected reward ν to the learning unit 45.

The learning unit 45 learns the policy determination unit 46 based on the estimated risk corrected reward ν.

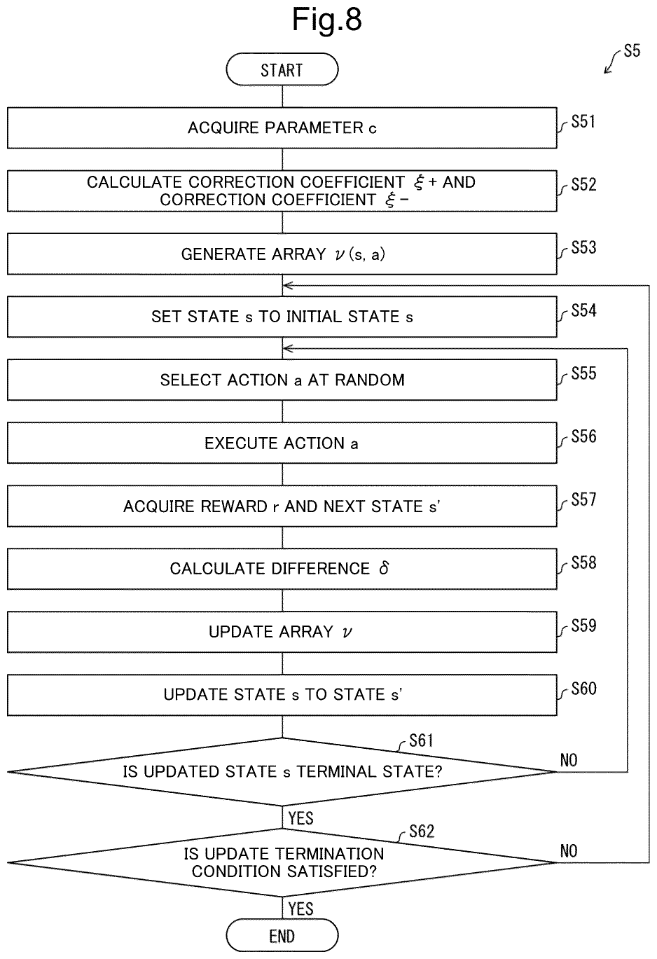

FIG. 8 is a flowchart illustrating a flow S4 of processing executed by the policy learning apparatus 40.

In step S51, the calculation unit 42 acquires the parameter c.

In step S52, the calculation unit 42 calculates the correction coefficient ξ₊ and the correction coefficient ξ₋ based on the parameter c. The calculation unit 42 supplies the calculated correction coefficient ξ₊ and correction coefficient ξ₋ to the update unit 43.

In step S53, the setting unit 41 generates an array ν(S, A) that stores an estimated value of the risk corrected reward in each state and each action.

In step S54, the setting unit 41 sets the state s to the initial state s. Then, the setting unit 41 sets the risk corrected reward estimated value ν(s, a) in the initial state s and the action a as the initial value. The setting unit 41 supplies the set risk corrected reward estimated value ν(s, a) to the update unit 43. The setting unit 41 supplies the state s to the policy determination unit 46. That is, the policy learning apparatus 40 starts simulation.

In step S55, the policy determination unit 46 randomly selects the action a. As an example, the policy determination unit 46 has a configuration to select a most valuable action a with a probability of 1−ε, and a configuration to select a random action a with a probability of ε.

In step S56, the policy determination unit 46 supplies the action a to the execution unit 47. The execution unit 47 causes the agent to execute the action a in simulation, for example, based on the action a supplied from the policy determination unit 46.

In step S57, the update unit 43 acquires, for example, a reward r obtained by the agent executing the action a in simulation and the next state s′.

In step S58, the update unit 43 calculates the risk corrected reward estimated value ν(s′, a). Then, the update unit 43 calculates the difference δ using the above-described Expression (17).

In step S59, the update unit 43 calculates the risk corrected reward estimated value ν(s′, a) and updates the array ν(S, A).

In step S60, the update unit 43 updates the risk corrected reward ν that is the estimation amount based on the risk corrected reward estimated value ν(s, a), the difference δ, the correction coefficient ξ₊, and the correction coefficient ξ₋ using Expression (8).

Here, as described above, the update unit 43 uses either the correction coefficient ξ₊ or the correction coefficient ξ₋ according to the positive or negative of the difference δ. In other words, the calculation unit 42 calculates any one of the correction coefficient ξ₊ and the correction coefficient ξ₋ according to the positive or negative of the difference δ, and supplies any one of the calculated correction coefficient ξ₊ and correction coefficient ξ₋ to the update unit 43.

Then, the update unit 43 updates the state s from the initial state s to the next state s′.

In step S61, the update unit 43 determines whether the updated state s is the terminal state.

In step S61, in a case where it is determined that the state is not the terminal state (step S61: NO), the policy learning apparatus 40 returns to the processing of step S55.

In a case where it is determined in step S61 that the state is the terminal state (step S61: YES), the update unit 43 determines in step S62 whether the update termination condition is satisfied. As an example, the update unit 43 determines whether predetermined conditions such as the number of episodes and reward are satisfied.

In step S62, in a case where it is determined that the final condition is not satisfied (step S62: NO), the policy learning apparatus 40 returns to the processing of step S54.

On the other hand, in a case where it is determined in step S62 that the final condition is satisfied (step S62: YES), the policy learning apparatus 40 ends the processing illustrated in FIG. 8.

As described above, in the policy learning apparatus 40, the risk corrected reward can be estimated using one estimation amount using the dimensionless parameter c. Therefore, in the policy learning apparatus 40, it is possible to obtain an effect that the risk sensitive reinforcement learning can be performed with one estimation amount and the degree of risk consideration does not change depending on the magnitude of reward.

The reinforcement learning method described above is an example, and for example, risk sensitive reinforcement learning described in Deletang et al., Model-Free Risk-Sensitive Reinforcement Learning or the like may be used.

### (Operation of Policy Selection Apparatus)

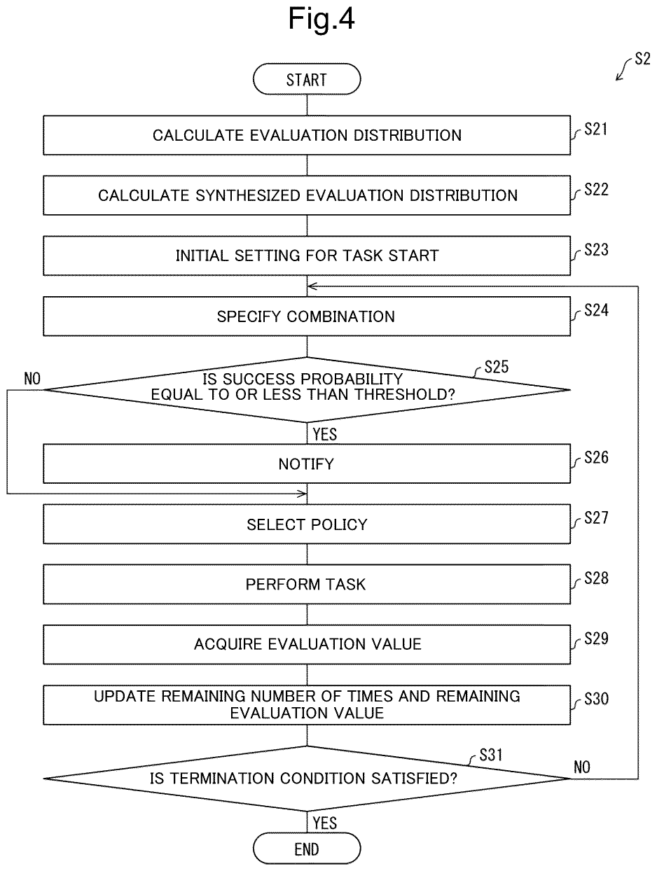

Next, the operation of the policy selection apparatus 2 will be described with reference to FIG. 4. FIG. 4 is a second flowchart illustrating an operation flow S2 of the policy selection apparatus 2. In the following, for convenience of description, a case where a value cumulatively obtained from the evaluation value for each task is the sum of the evaluation values will be described as an example, but the present disclosure is not limited thereto, and the value cumulatively obtained from the evaluation value for each task may be a value calculated from the evaluation value for each task by a recurrence formula.

In step S21, the evaluation distribution calculation unit 11 calculates an evaluation distribution for each of the plurality of policies. The evaluation distribution is an evaluation distribution indicating a distribution of evaluation values when one task is executed.

In one aspect, the evaluation distribution calculation unit 11 calculates an evaluation distribution using the environment execution unit 50. That is, the evaluation distribution calculation unit 11 may calculate the evaluation distribution by causing the agent 51 (AGV51a) that has set any policy to execute a plurality of tasks using the environment execution unit 50 and acquiring the evaluation value from the evaluation unit 57 (computer 57a).

In one aspect, the evaluation distribution calculation unit 11 may store the calculated evaluation distribution in the storage unit 16.

In step S22, the synthesized evaluation distribution calculation unit 12 calculates a synthesized evaluation distribution based on the evaluation distribution calculated in step S11 (evaluation distribution stored in the storage unit 16). The synthesized evaluation distribution is a distribution of evaluation values when any number of tasks are executed with any combination of policies.

For example, the synthesized evaluation distribution calculation unit 12 calculates distribution of evaluation values when X (X is an integer equal to or more than 1 and equal to or less than the total number of tasks) tasks are executed in each combination selected from a plurality of policies (the same policy can be selected a plurality of times). In a case where X is 1, the evaluation distribution itself may be used.

In one aspect, the synthesized evaluation distribution calculation unit 12 may calculate the synthesized evaluation distribution by sampling the evaluation distribution.

For example, in a case where the selection target is four policies, the synthesized evaluation distribution calculation unit 12 may obtain a distribution of evaluation values when X (1<X≤N) tasks are executed in each combination selected from the four policies as follows. In a case where the number of times of executing each of the four policies is set to (i, j, k, l) in X tasks (i+j+k+l=X), the synthesized evaluation distribution calculation unit 12 may randomly perform sampling from the evaluation distribution of each of the four policies (i, j, k, l)×a predetermined number of times (for example, 1000 times), and calculate the obtained distribution as the synthesized evaluation distribution. The same applies to a case where the number of policies is other than four.

In one aspect, the synthesized evaluation distribution calculation unit 12 may calculate the synthesized evaluation distribution by convolution integration of the evaluation distribution. For example, the synthesized evaluation distribution calculation unit 12 may calculate the synthesized evaluation distribution by transforming the evaluation distribution into a probability density distribution, performing convolution integration, and returning the probability density distribution to a cumulative density distribution. For the transformation into the probability density distribution, for example, a known method such as smoothing of a histogram or a bootstrap method can be used. The convolution integration can be performed by, for example, multiplying together, for a number of times included in a combination (for example, in a case of four policies described above, (i, j, k, l) times), probability density distributions related to evaluation distributions of policies after fast Fourier transforming them, and inverse Fourier transforming the result.

By performing the convolution integration of the evaluation distribution, the synthesized evaluation distribution calculation unit 12 has an advantage that it is not necessary to determine the required number of samplings and an advantage that it is natural since all data of the evaluation distribution can be used and a smooth synthesized evaluation distribution without rattling can be obtained as compared with a case of sampling the evaluation distribution.

In one aspect, the synthesized evaluation distribution calculation unit 12 may calculate a synthesized evaluation distribution before execution of the first task and store the synthesized evaluation distribution in the storage unit 16. As a result, the amount of calculation at the time of executing the task can be reduced.

In step S23, the control unit 10 performs initial setting for execution of the task by the agent. For example, the control unit 10 may set the remaining number of times of the task, the remaining evaluation value, a threshold of the success probability serving as a notification criterion, and the like.

In step S24, based on the synthesized evaluation distribution (synthesized evaluation distribution stored in the storage unit 16) calculated by the synthesized evaluation distribution calculation unit 12, the specification unit 13 specifies a combination of policies having the highest possibility of achieving the objective when the remaining number of tasks are executed.

It is assumed that the total of the evaluation values is equal to or more than R as a result of the objective executing N tasks. With reference to the synthesized evaluation distribution related to the remaining number of times (N—the number of times of the task that has already been executed), a combination (for example, in an example where the policy described above is four, (i, j, k, l) combinations (i+j+k+l=N—the number of tasks already performed)) of policies is specified in which a probability that the sum of evaluation values obtained by executing the remaining number of times of tasks is equal to or more than the remaining evaluation value (R−Σ (evaluation value of each time that has already been executed)) is the highest. At this time, the specification unit 13 may provide the probability related to the specified combination to the notification unit 15.

In step S25, the notification unit 15 determines whether the probability of achieving the objective when executing the remaining number of tasks is equal to or less than a threshold. For example, the notification unit 15 determines whether the probability provided from the specification unit 13 is equal to or less than a threshold. Then, in a case where the probability of achieving the objective is equal to or less than the threshold (YES in step S25), the notification unit 15 notifies the user that the success probability is equal to or less than the threshold in step S26. As a result, the user can know in advance that the possibility of failure is high.

In a case where the probability of achieving the objective in step S25 exceeds the threshold (NO in step S25), or after execution of step S26, in step S27, the selection unit 14 selects a policy to be used by the agent in the next task from the policies included in the combination specified by the specification unit 13.

In one aspect, the selection unit 14 may select a policy having the largest weighting of the variance with respect to the evaluation value related to the policy among the policies included in the combination specified by the specification unit 13. The weighting of the variance with respect to the evaluation value related to the policy refers to weighting of the variance (for example, the parameter c described above) with respect to the evaluation value used in the reinforcement learning of the learning model that enables the policy. It can be said that a policy having the largest weighting of the variance with respect to the evaluation value related to the policy is a risk preferable policy. With this execution, it is possible to notify that the failure probability is high early.

In another aspect, the selection unit 14 may select a policy according to criteria such as: an order of statistics (for example, variance) in an evaluation distribution related to a policy; complete randomness; an order of frequency of execution included in a combination; or selecting a random policy based on a probability distribution related to a frequency of execution included in a combination.

In step S28, the control unit 10 causes the agent 51 to execute the next task by the selected policy via the environment execution unit 50. The environment execution unit 50 used in step S21 and the environment execution unit 50 used in step S28 may be different from each other. For example, the environment execution unit 50 used in step S21 may be one in which the agent 51 executes a task in the simulation model, and the environment execution unit 50 used in step S28 may be one in which the agent 51 executes a task in the actual environment.

In step S29, the control unit 10 acquires the evaluation value of the task executed by the agent 51 according to the selected policy from the environment execution unit 50.

In step S30, the control unit 10 decreases the remaining number of times of the task by one, and subtracts the evaluation value obtained in step S29 from the remaining evaluation value.

The update unit 17 may update the evaluation distribution stored in the storage unit 16 by using the policy selected by the selection unit 14 and the evaluation value of the task executed by the policy. The update unit 17 may further cause the synthesized evaluation distribution calculation unit 12 to update the synthesized evaluation distribution based on the updated evaluation distribution. As a result, the evaluation distribution can be made more accurate.

In particular, in a case where the environment execution unit 50 used in step S21 is one in which the agent 51 executes a task in the simulation model, and the environment execution unit 50 used in step S28 is one in which the agent 51 executes a task in the actual environment, the evaluation value obtained in the actual environment can be applied to the evaluation distribution, and the evaluation distribution can be made more accurate.

In step S31, the control unit 10 determines whether the termination condition (whether the remaining number of times of the task is 0) is satisfied, and in a case where the termination condition is not satisfied (NO in step S31), the process returns to step S24. In a case where the termination condition is satisfied (YES in step S31), the processing is terminated.

### EXAMPLES

Next, an example will be described. As a plurality of policies to be selected, in the above-described reinforcement learning method, a learning model subjected to reinforcement learning with the parameter C=−4.0, a learning model subjected to reinforcement learning with the parameter C=−1.0, a learning model subjected to reinforcement learning with the parameter C=0.0, and a learning model subjected to reinforcement learning with the parameter C=1.0 are used.

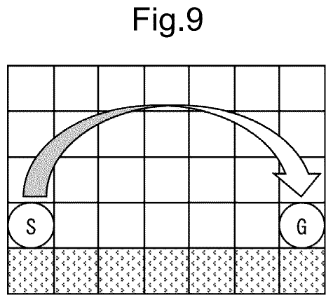

FIG. 9 is a diagram for explaining a task used in an actual example. The task illustrated in FIG. 9 is also referred to as cliff walking, and is a task of moving from the start of the first square from the left and the fourth square from the top to the goal of the first square from the right and the fourth square from the top in a grid of five squares in length and seven squares in width. The first row from the bottom is a cliff. The agent 51 may receive its position as an observation result. The agent 51 can move in four directions. When the agent 51 reaches the goal, a reward (evaluation value) is obtained, and the task ends. In each step, the agent 51 moves in a direction following the policy with a probability of 50%, and moves in a random direction with a probability of 50% (however, the first two steps move in the direction following the 100% policy). In each step, a small penalty (negative evaluation value) is given. When the agent 51 makes a goal less than the first specified number of steps, a bonus reward (evaluation value) is granted. When the agent 51 falls off the cliff, a penalty (negative evaluation value) is given, and the agent 51 is returned to the start point. If the second specified number of steps is exceeded, a penalty (negative evaluation value) is obtained and the task is terminated. As a result of cliff walking 10 times (10 episodes), it was targeted that the total evaluation value be equal to or more than −10.0.

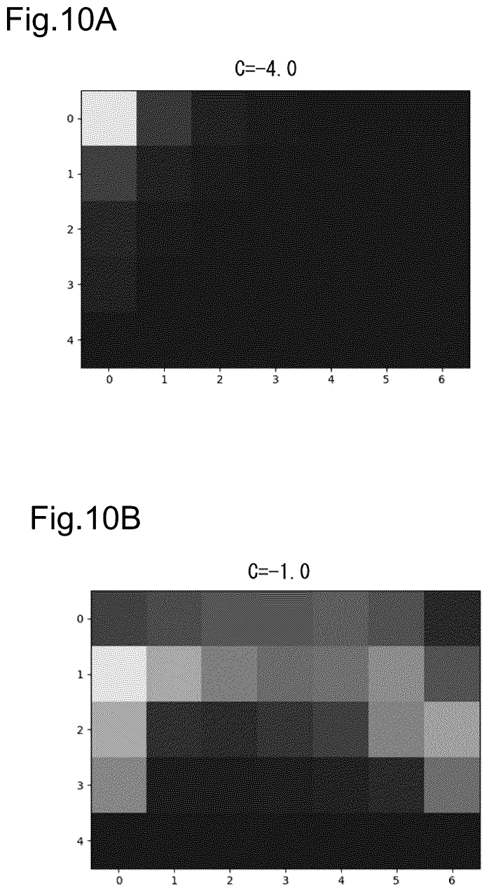

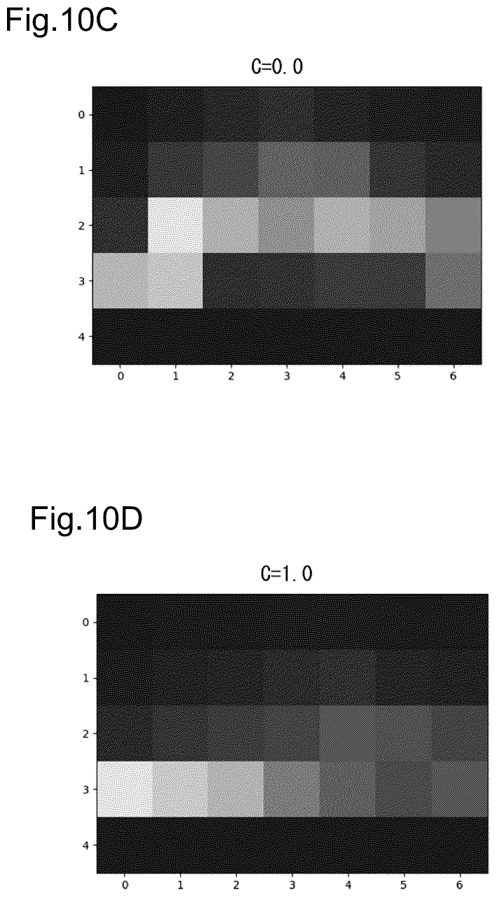

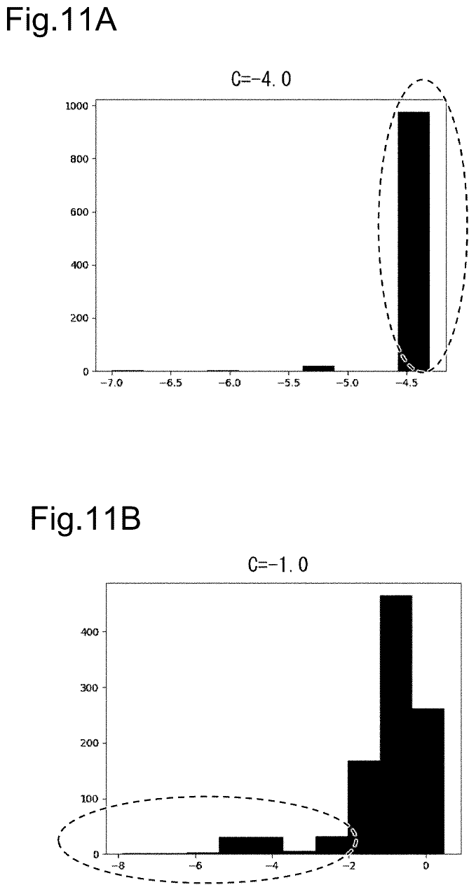

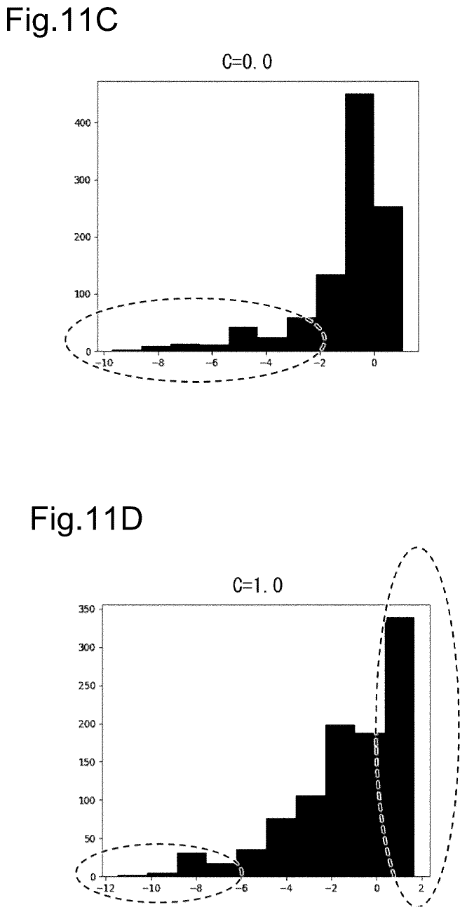

The results of repeating one task (10,000 times) are illustrated in FIGS. 10A, 10B, 10C, 10D, 11A, 11B, 11C and 11D. FIG. 10A is a first diagram illustrating a first execution result of a task according to the present disclosure. FIG. 10B is a second diagram illustrating a first execution result of a task according to the present disclosure. FIG. 10C is a third diagram illustrating a first execution result of a task according to the present disclosure. FIG. 10D is a fourth diagram illustrating a first execution result of a task according to the present disclosure. FIGS. 10A, 10B, 10C and 10D illustrate a route through which the agent 51 passes. FIG. 11A is a first diagram illustrating a second execution result of a task according to the present disclosure. FIG. 11B is a second diagram illustrating a second execution result of a task according to the present disclosure. FIG. 11C is a third diagram illustrating a second execution result of a task according to the present disclosure. FIG. 11D is a fourth diagram illustrating a second execution result of a task according to the present disclosure. FIG. 11 illustrates an evaluation distribution calculated by the policy selection apparatus.

In the policy with the parameter C=−4.0, as illustrated in FIG. 10A, it continues to stay at an upper left of the grid, the task is terminated after exceeding the second specified number of steps, and the policy was one excluded from selection targets. As illustrated in FIG. 11A, there was almost no variance, and the frequency of the low evaluation value was high (within the dotted circle). The average and variance of the evaluation values were −4.3 and 0.03.

In the policy with the parameter C=−1.0 (risk avoidance), as illustrated in FIG. 10B, it often passed through a route via an upper side of the grid. As illustrated in FIG. 11B, there were few major failures (within the dotted circle), but the average of the evaluation values was low. The average and variance of the evaluation values were −1.02 and 1.50.

In the policy with the parameter C=0.0 (risk neutrality), as illustrated in FIG. 10C, it often passed through a route via a center of the grid. As illustrated in FIG. 11C, there were major failures (within the dotted circle), but the average of the evaluation values was high. The average and variance of the evaluation values were −0.92 and 3.4.

In the policy with the parameter C=1.0 (risk preference), as illustrated in FIG. 10D, it often passed through a route via a lower side of the grid. As illustrated in FIG. 11D, the number of major failures had increased, but the number of major successes had also increased (in the dotted circle). The average and variance of the evaluation values were −1.2 and 6.5.

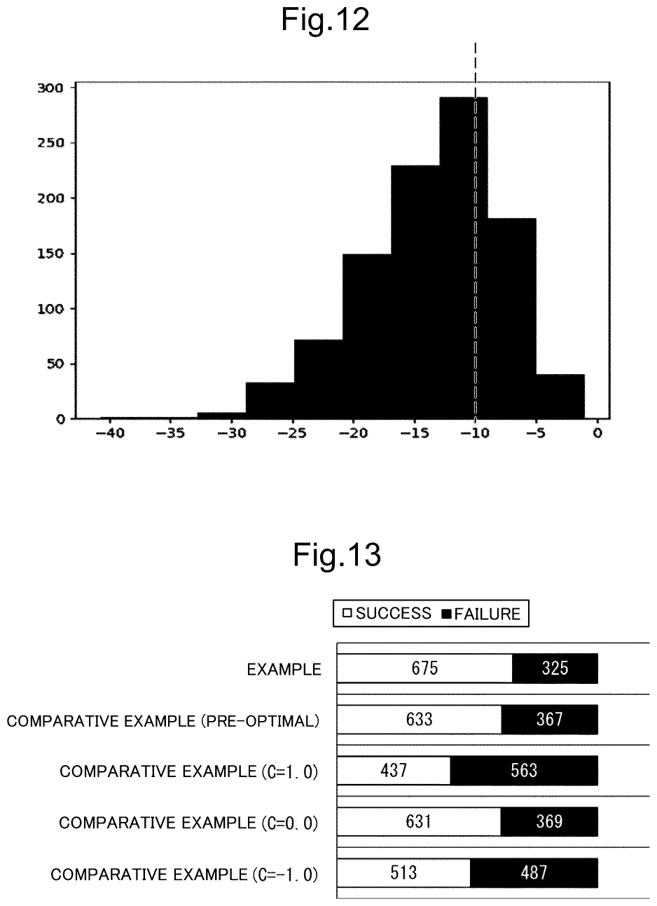

The policy selection apparatus (re)sampled the evaluation distribution obtained as described above to calculate a synthesized evaluation distribution. The number of samplings was 1000. For example, a synthesized evaluation distribution for 10 tasks and all with a C=0.0 (risk neutral) policy is illustrated in FIG. 12. FIG. 12 is a diagram for explaining selection of a policy according to the present disclosure.

Then, the policy selection apparatus calculated a probability (in the case of the synthesized evaluation distribution illustrated in FIG. 12, the probability is on the right side of the broken line) that the target value is equal to or more than −10 in each synthesized evaluation distribution. Then, the policy selection apparatus specified a combination having the highest probability before executing each task, and selected a policy to be used in the next task from the combination. The above was executed for 10 tasks, and it was determined whether the objective was finally achieved (success) or not achieved (failure).

The above was repeated 1000 times, and the number of successes and the number of failures were counted. As a comparative example, the number of successes and the number of failures were counted 1000 times in the case of using the policies with C=1.0 (risk preference), C=0.0 (risk neutral), and C=−1.0 (risk avoidance) in all the 10 tasks and in the case of executing the 10 tasks in the specified combination before executing the first task. The results are illustrated in FIG. 13. FIG. 13 is a diagram illustrating a third execution result of a task according to the present disclosure.

As illustrated in FIG. 13, the result of the example embodiment in which the policies to be used are switched according to the situation during the execution was the best. To confirm that the switching was actually occurring, at a point of remaining five times, (the number of times i with C=−4.0, the number of times j with C=−1.0, the number of times k with C=0.0, and the number of times l with C=1.0) in the combinations specified were observed. The results are illustrated below.
(0, 5, 0, 0)(0, 5, 0, 0)(0, 5, 0, 0)(0, 0, 3, 2)(0, 0, 5, 0)(0, 5, 0, 0)(0, 5, 0, 0)(0, 5, 0, 0) (0, 0, 5, 0) (0, 5, 0, 0)

The combination specified before executing the first task is (0, 1, 9, 0), and it can be seen that the situation has changed. In many cases, it is a situation preferable to execute a policy with C=−1.0 (risk avoidance), but there were also cases where it is a situation preferable to execute a policy with C=1.0 (risk seeking). As described above, it has been illustrated that switching of policies according to the situation is performed.

In a case where the policy selection apparatus calculated the synthesized evaluation distribution using the convolution integration, 685 cases succeeded and 315 cases failed, and it was similarly effective. At a point of remaining five times, (the number of times i with C=−4.0, the number of times j with C=−1.0, the number of times k with C=0.0, and the number of times l with C=1.0) in the combinations specified where as follows, and it was illustrated that switching of policies according to the situation was performed as described above.
(0, 0, 5, 0) (0, 5, 0, 0) (0, 0, 5, 0) (0, 5, 0, 0) (0, 0, 5, 0) (0, 0, 0, 5) (0, 5, 0, 0) (0, 5, 0, 0) (0, 0, 5, 0) (0, 0, 5, 0)

The technique described in T. Saiki and S. Arai, “Switching Policies based on Multi-Objective Reinforcement Learning for Adaptive Traffic Signal Control,” 2022 61st Annual Conference of the Society of Instrument and Control Engineers (SICE), Kumamoto, Japan, 2022, pp. 488-493 does not select each policy so that the possibility of achieving the objective as a whole is increased in sequential execution of a plurality of tasks.

The present disclosure has been made in view of the above problem, and an exemplary object of the present disclosure is to provide a technique of selecting each policy so that the possibility of achieving the objective as a whole is increased in sequential execution of a plurality of tasks.

According to an exemplary aspect of the present disclosure, there is an exemplary effect that it is possible to provide a technique of selecting a policy of each time such that a possibility of achieving an objective as a whole is increased in sequential execution of a plurality of tasks.

### [Implementation Example by Software]

Some or all of the functions of the policy selection apparatuses 1 and 2 and the policy learning apparatus 40 (hereinafter, also referred to as “each of the above apparatuses”) may be enabled by hardware such as an integrated circuit (IC chip) or may be enabled by software.

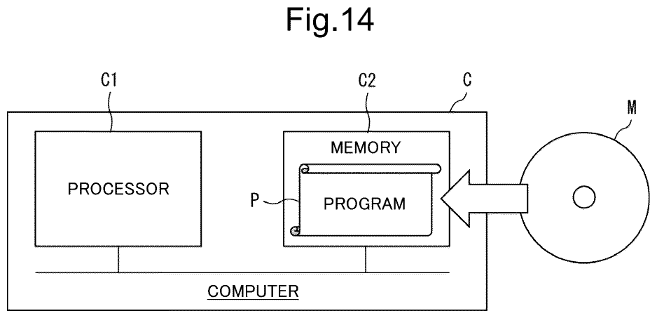

In the latter case, each of the above apparatuses is achieved by, for example, a computer that executes a command of a program as software for achieving each function. An example of such a computer (hereinafter, referred to as a computer C) is illustrated in FIG. 14. FIG. 14 is a block diagram illustrating a configuration of a computer that functions as each apparatus according to the present disclosure. Specifically, FIG. 14 is a block diagram illustrating a hardware configuration of the computer C functioning as each of the above apparatuses.

The computer C includes at least one processor C1 and at least one memory C2. A program P for causing the computer C to operate as each of the above apparatuses is recorded in the memory C2. In the computer C, by the processor C1 reading the program P from the memory C2 and executing the program P, each function of each of the above apparatuses is achieved.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, a combination of these, or the like can be used. As the memory C2, for example, a flash memory, a hard disk drive (HDD), a solid state drive (SSD), a combination of these, or the like can be used.

The computer C may further include a random access memory (RAM) for loading the program P at the time of execution and temporarily storing various types of data. The computer C may further include a communication interface for transmitting and receiving data to and from another apparatus. The computer C may further include an input/output interface for connecting input/output equipment such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like may be used.

The computer C may acquire the program P via such a recording medium M. The program P may be transmitted via a transmission medium. As such a transmission medium, for example, a communication network, a broadcast wave, or the like may be used. The computer C can also acquire the program P via such a transmission medium.

Each of the above functions of each of the above apparatuses may be achieved by a single processor provided in a single computer, may be achieved in cooperation with a plurality of processors provided in a single computer, or may be achieved in cooperation with a plurality of processors provided in a plurality of computers. The program for causing each of the above apparatuses to achieve each of the above functions may be stored in a single memory provided in a single computer, may be stored in a distributed manner in a plurality of memories provided in a single computer, or may be stored in a distributed manner in a plurality of memories provided in a plurality of computers.

### [Supplementary Information 1]

The present disclosure includes techniques described in the following Supplementary Notes. However, the present disclosure is not limited to the techniques described in the following Supplementary Notes, and various modifications can be made within the scope described in the claims.

### (Supplementary Note 1)

A policy selection apparatus selecting a policy to be used by an agent in a next task from a plurality of policies each time for sequential execution of a plurality of tasks executed by the agent that operates autonomously, wherein
an objective for a value cumulatively obtained from an evaluation value for each task is set in the plurality of tasks, the policy selection apparatus including:
an evaluation distribution calculation unit that calculates an evaluation distribution indicating a distribution of evaluation values in the case where one task is executed for each of the plurality of policies;
a synthesized evaluation distribution calculation unit that calculates, based on the evaluation distribution, a synthesized evaluation distribution obtained by estimating a distribution of evaluation values in the case where any number of tasks are executed with any combination of policies;
a specification unit that specifies, based on the synthesized evaluation distribution, a combination of policies that are most likely to achieve the objective in the case where a remaining number of tasks are performed; and
a selection unit that selects a policy to be used by the agent in the next task from the policies included in the combination specified by the specification unit.

### (Supplementary Note 2)

The policy selection apparatus according to Supplementary Note 1, wherein the agent determines an autonomous operation by using a learning model that has been subjected to reinforcement learning with a reward based on an expected value and a variance of the evaluation value of the task, and
the plurality of policies are policies in which the agent operates using the learning model in which reinforcement learning is performed in which weightings of the variance with respect to the expected value in the reward are different from each other.

### (Supplementary Note 3)

The policy selection apparatus according to Supplementary Note 2, wherein the selection unit selects a policy having the largest weighting related to the policy among the policies included in the combination specified by the specification means.

### (Supplementary Note 4)

The policy selection apparatus according to any one of Supplementary Notes 1 to 3, further including a storage unit, wherein
the evaluation distribution calculation unit stores the evaluation distribution calculated in the storage unit,
the synthesized evaluation distribution calculation unit calculates the synthesized evaluation distribution based on the evaluation distribution stored in the storage unit before execution of a first task, and stores the synthesized evaluation distribution in the storage unit, and
the specification means specifies the combination based on the synthesized evaluation distribution stored in the storage means.

### (Supplementary Note 5)

The policy selection apparatus according to Supplementary Note 4, further including an update unit for updating the evaluation distribution stored in the storage unit using the policy selected by the selection means and the evaluation value of the task executed by the policy.

### (Supplementary Note 6)

The policy selection apparatus according to any one of Supplementary Notes 1 to 5, further including a notification unit for notifying that a probability of achieving the objective has become equal to or less than a threshold in the case where the remaining number of tasks is executed.

### (Supplementary Note 7)

The policy selection apparatus according to any one of Supplementary Notes 1 to 6, wherein the evaluation distribution calculation unit calculates the evaluation distribution using an environment in which the agent executes the task or a simulation model of the environment.

### (Supplementary Note 8)

The policy selection apparatus according to any one of Supplementary Notes 1 to 7, wherein the synthesized evaluation distribution calculation unit calculates the synthesized evaluation distribution by sampling or convolution integration of the evaluation distribution.

### (Supplementary Note 9)

A policy selection method for selecting a policy to be used by an agent in a next task from a plurality of policies each time for sequential execution of a plurality of tasks executed by the agent that operates autonomously, wherein
an objective for a value cumulatively obtained from an evaluation value for each task is set in the plurality of tasks, the policy selection method including:
calculating an evaluation distribution indicating a distribution of evaluation values in the case where one task is executed for each of the plurality of policies;
calculating, based on the evaluation distribution, a synthesized evaluation distribution obtained by estimating a distribution of evaluation values in the case where any number of tasks are executed with any combination of policies;
specifying, based on the synthesized evaluation distribution, a combination of policies that are most likely to achieve the objective in the case where a remaining number of tasks are performed; and
selecting a policy to be used by the agent in the next task from the policies included in the combination specified.

### (Supplementary Note 10)

A policy selection program for causing a computer to function as a policy selection apparatus that selects a policy to be used by an agent in a next task from a plurality of policies each time for sequential execution of a plurality of tasks executed by the agent that operates autonomously, wherein
an objective for a value cumulatively obtained from an evaluation value for each task is set in the plurality of tasks, the policy selection program causing the computer to function as:
the policy selection program causes the computer to execute:
an evaluation distribution calculation unit that calculates an evaluation distribution indicating a distribution of evaluation values in the case where one task is executed for each of the plurality of policies;
a synthesized evaluation distribution calculation unit that calculates, based on the evaluation distribution, a synthesized evaluation distribution obtained by estimating a distribution of evaluation values in the case where any number of tasks are executed with any combination of policies;
a specification unit that specifies, based on the synthesized evaluation distribution, a combination of policies that are most likely to achieve the objective in the case where a remaining number of tasks are performed; and
a selection unit that selects a policy to be used by the agent in the next task from the policies included in the combination specified by the specification unit.

### [Supplementary Information 2]

The present disclosure includes techniques described in the following Supplementary Notes. However, the present disclosure is not limited to the techniques described in the following Supplementary Notes, and various modifications can be made within the scope described in the claims.

### (Supplementary Note 1)

A policy selection apparatus selecting a policy to be used by an agent in a next task from a plurality of policies each time for sequential execution of a plurality of tasks executed by the agent that operates autonomously, wherein
an objective for a value cumulatively obtained from an evaluation value for each task is set in the plurality of tasks, the policy selection apparatus including
at least one processor, the at least one processor executing:
evaluation distribution calculation processing of calculating an evaluation distribution indicating a distribution of evaluation values in the case where one task is executed for each of the plurality of policies;
synthesized evaluation distribution calculation processing of calculating, based on the evaluation distribution, a synthesized evaluation distribution obtained by estimating a distribution of evaluation values in the case where any number of tasks are executed with any combination of policies;
specification processing of specifying, based on the synthesized evaluation distribution, a combination of policies that are most likely to achieve the objective in the case where a remaining number of tasks are performed; and
selection processing of selecting a policy to be used by the agent in the next task from the policies included in the combination specified in the specification processing.

The policy selection apparatus may further include a memory. The memory may store a program for causing the at least one processor to execute each processing.

### (Supplementary Note 2)

The policy selection apparatus according to Supplementary Note 1, wherein the agent determines an autonomous operation by using a learning model that has been subjected to reinforcement learning with a reward based on an expected value and a variance of the evaluation value of the task, and
the plurality of policies are policies in which the agent operates using the learning model in which reinforcement learning is performed in which weightings of the variance with respect to the expected value in the reward are different from each other.

### (Supplementary Note 3)

The policy selection apparatus according to Supplementary Note 2, wherein in the selection processing, the at least one processor selects a policy having the largest weighting related to the policy among the policies included in the combination specified in the specification processing.

### (Supplementary Note 4)

The policy selection apparatus according to Supplementary Note 1, further including a storage, wherein
in the evaluation distribution calculation processing, the at least one processor stores the evaluation distribution calculated in the storage,
in the synthesized evaluation distribution calculation processing, the at least one processor calculates the synthesized evaluation distribution based on the evaluation distribution stored in the storage before execution of a first task, and stores the synthesized evaluation distribution in the storage, and
in the specification processing, the at least one processor specifies the combination based on the synthesized evaluation distribution stored in the storage.

### (Supplementary Note 5)

The policy selection apparatus according to Supplementary Note 4, wherein the at least one processor further executes update processing of updating the evaluation distribution stored in the storage using the policy selected in the selection processing and the evaluation value of the task executed by the policy.

### (Supplementary Note 6)

The policy selection apparatus according to Supplementary Note 1, wherein the at least one processor further executes notification processing of notifying that a probability of achieving the objective has become equal to or less than a threshold in the case where the remaining number of tasks are performed.

### (Supplementary Note 7)

The policy selection apparatus according to Supplementary Note 1, wherein in the evaluation distribution calculation processing, the at least one processor calculates the evaluation distribution using an environment in which the agent executes the task or a simulation model of the environment.

### (Supplementary Note 8)

The policy selection apparatus according to Supplementary Note 1, wherein in the synthesized evaluation calculation processing, the at least one processor calculates the synthesized evaluation distribution by sampling or convolution integration of the evaluation distribution.

1. A policy selection apparatus selecting a policy to be used by an agent in a next task from a plurality of policies each time for sequential execution of a plurality of tasks executed by the agent that operates autonomously, wherein
an objective for a value cumulatively obtained from an evaluation value for each task is set in the plurality of tasks, the policy selection apparatus comprising:
at least one memory configured to store instructions; and
at least one processor configured to execute the instructions to:
calculate an evaluation distribution indicating a distribution of evaluation values in the case where one task is executed for each of the plurality of policies;
calculate, based on the evaluation distribution, a synthesized evaluation distribution obtained by estimating a distribution of evaluation values in the case where any number of tasks are executed with any combination of policies;
specify, based on the synthesized evaluation distribution, a combination of policies that are most likely to achieve the objective in the case where a remaining number of tasks are performed; and
select a policy to be used by the agent in the next task from the policies included in the combination specified.

2. The policy selection apparatus according to claim 1, wherein
the agent determines an autonomous operation by using a learning model that has been subjected to reinforcement learning with a reward based on an expected value and a variance of the evaluation value of the task, and
the plurality of policies are policies in which the agent operates using the learning model in which reinforcement learning is performed in which weightings of the variance with respect to the expected value in the reward are different from each other.

3. The policy selection apparatus according to claim 2, wherein the at least one processor is further configured to execute the instructions to:
select a policy having the largest weighting related to the policy among the policies included in the combination specified.

4. The policy selection apparatus according to claim 1, wherein the at least one processor is further configured to execute the instructions to:
store the evaluation distribution calculated,
calculate the synthesized evaluation distribution based on the evaluation distribution stored before execution of a first task, and store the synthesized evaluation distribution, and
specify the combination based on the synthesized evaluation distribution stored.

5. The policy selection apparatus according to claim 4, wherein the at least one processor is further configured to execute the instructions to:
update the evaluation distribution stored using the policy selected and the evaluation value of the task executed by the policy.

6. The policy selection apparatus according to claim 1, wherein the at least one processor is further configured to execute the instructions to:
notify that a probability of achieving the objective has become equal to or less than a threshold in the case where the remaining number of tasks is executed.

7. The policy selection apparatus according to claim 1, wherein the at least one processor is further configured to execute the instructions to:
calculate the evaluation distribution using an environment in which the agent executes the task or a simulation model of the environment.

8. The policy selection apparatus according to claim 1, wherein the at least one processor is further configured to execute the instructions to:
calculate the synthesized evaluation distribution by sampling or convolution integration of the evaluation distribution.

9. A policy selection method for selecting a policy to be used by an agent in a next task from a plurality of policies each time for sequential execution of a plurality of tasks executed by the agent that operates autonomously, wherein
an objective for a value cumulatively obtained from an evaluation value for each task is set in the plurality of tasks, the policy selection method comprising:
calculating an evaluation distribution indicating a distribution of evaluation values in the case where one task is executed for each of the plurality of policies;
calculating, based on the evaluation distribution, a synthesized evaluation distribution obtained by estimating a distribution of evaluation values in the case where any number of tasks are executed with any combination of policies;
specifying, based on the synthesized evaluation distribution, a combination of policies that are most likely to achieve the objective in the case where a remaining number of tasks are performed; and
selecting a policy to be used by the agent in the next task from the policies included in the combination specified.

10. A non-transitory computer-readable recording medium having a policy selection program for causing a computer to function as a policy selection apparatus that selects a policy to be used by an agent in a next task from a plurality of policies each time for sequential execution of a plurality of tasks executed by the agent that operates autonomously, wherein
an objective for a value cumulatively obtained from an evaluation value for each task is set in the plurality of tasks, the policy selection program causing the computer to execute:
calculating an evaluation distribution indicating a distribution of evaluation values in the case where one task is executed for each of the plurality of policies;
calculating, based on the evaluation distribution, a synthesized evaluation distribution obtained by estimating a distribution of evaluation values in the case where any number of tasks are executed with any combination of policies;
a specification means for specifying, based on the synthesized evaluation distribution, a combination of policies that are most likely to achieve the objective in the case where a remaining number of tasks are performed; and
a selection means for selecting a policy to be used by the agent in the next task from the policies included in the combination specified by the specification means.
